(19) United States
(12) Patent Application Publication
(10) Pub. No.: US 2026/0167217 A1
(43) Pub. Date: Jun. 18, 2026

(54) WARNING DEVICE FOR WARNING OF A COLLISION OBJECT

(71) Applicant: MEKRA Lang GmbH & Co. KG, Ergersheim (DE)

(72) Inventors: Michael SCHEFFOLD, Bad Windsheim (DE); Oliver HUTZLER, Uffenheim (DE); Andreas ENZ, Burgbernheim (DE)

(21) Appl. No.: 19/417,004

(22) Filed: Dec. 11, 2025

(30) Foreign Application Priority Data
Dec. 13, 2024 (DE) 102024137701.1

(51) Int. Cl. B60W 50/16; B60W 50/14

(52) U.S. Cl. CPC B60W 50/16; B60W 2050/143; B60W 2050/146

(57) ABSTRACT

Disclosed is a warning device for warning an operator of a vehicle of a collision object during an operation comprising: an attention-area determination unit configured to determine an attention area, which is an area to which an attention of the operator is directed, an environment monitoring unit configured to at least partially monitor an environment around the vehicle, to determine a risk of collision for an object that is present in the monitored environment, and to detect an object as the collision object for which there is a risk of collision and which is present outside the attention area, and an output unit configured to output a warning signal when detecting the collision object.

### BACKGROUND

The present disclosure relates to a warning device for warning an operator of a vehicle of a collision object.

It is known that when operating a vehicle, such as a work machine or a construction machine, for example on a construction site, an operator's attention is directed to an activity performed with the vehicle (for example, excavating with an excavator bucket). Consequently, there is a risk that an approaching object, such as a vehicle or a person, or a stationary object in the vicinity of the vehicle may be overlooked or disregarded when operating the vehicle. As a result, a collision may occur with the approaching object or the stationary object, which often results in damage, possibly even rendering the vehicle unusable.

### SUMMARY

It is an object of the present disclosure to provide a warning device for warning an operator of a vehicle, which warns the operator of a collision object.

This object is solved by the warning device with the features according to the independent claim. Advantageous embodiments are the subject matter of the dependent claims.

A warning device according to the disclosure enables an operator of a vehicle to be warned of a collision object during an operation. The vehicle may be, for example, a truck, a work machine, or a construction machine. In particular, the vehicle may be an excavator (crawler excavator or wheeled excavator), a wheel loader, a bulldozer, a grader, a roller, a dump truck, a tractor, a combine harvester, a forage harvester, a planting machine, a harvester, a timber trailer, a timber stacker, a forestry tractor, a road sweeper, a trash truck, a snow plough, a gritting vehicle, a Unimog, a mobile lifting platform, a drilling rig, an asphalting machine, a riding lawn mower, a mining vehicle, a tunnel boring machine, a concrete pump, a fire engine, or a mobile or stationary crane. Operating the vehicle is understood to mean running the vehicle outside of public road traffic. In other words, the vehicle is operated to carry out work or for the purpose of maneuvering.

The warning device comprises an attention-area determination unit configured to determine an attention area, which is an area to which an attention of an operator is directed. The attention-area determination unit may use one or more methods known from the prior art for this purpose. For example, an operator's face may be detected and followed or tracked in order to determine the orientation of the operator's head. For example, the operator's eyes may be detected and tracked using image recognition (referred to as eye tracking) in order to determine the direction of view of the operator. Furthermore, the posture of the operator may be determined, for example, by a corresponding sensor system, which in particular is arranged in a seat on which the operator is sitting. The information obtained in this way makes it possible to determine a spatial area to which the operator's attention is directed. When determining the attention area, a normal field of view, in particular a binocular field of view, of a person may be assumed. For example, a person can detect an area of approximately 210° in the horizontal plane. Vertically, the range is between 60° and 70° upward and between 70° and 80° downward. A safety range, e.g. 10°, may be subtracted from the specified ranges to enable the field of view to be reliably determined. It should be noted that the attention area is not limited to a specific focal plane. The attention area may be determined continuously during operation. Continuous is also understood to mean periodic determination with a sufficiently short time interval.

Furthermore, the warning device comprises an environment monitoring unit configured to at least partially monitor an environment around the vehicle. Preferably, the environment monitoring unit is configured to completely monitor the environment around the vehicle. The environment monitoring unit may use one or more methods known from the prior art for this purpose. The environment monitoring unit may have one or more detection elements or sensors for this purpose. Examples include a radar detection element, a lidar detection element, an image detection element such as a camera, an ultrasonic detection element, and an infrared detection element. The detection element or elements of the environment monitoring unit each have a detection area with a characteristic horizontal and vertical extent. It is also conceivable that the environment monitoring unit comprises a combination of the aforementioned types of detection elements. Furthermore, depending on the type of vehicle, the detection elements may be arranged on the vehicle, i.e. on the outside of the vehicle, or integrated in the vehicle, e.g. in a body of the vehicle.

Furthermore, the environment monitoring unit is configured to determine a risk of collision for an object that is present in the monitored environment. For this purpose, the environment monitoring unit may detect and localize one or more objects using the information provided by the detection element(s), i.e. may determine the relative position of the object to the vehicle. Information from different detection elements may be merged in order to detect the object. The object does not necessarily have to correspond to a living being or an object. The object also does not have to be classified as an object type. However, it is possible to classify the object, e.g. using machine vision. This may also involve the continuous detection of one or more objects. Object monitoring (referred to as object tracking) may also be implemented in the monitoring unit.

The environment monitoring unit is configured to determine whether there is a risk of collision with the object after the object has been detected. The risk of collision with the object may be determined on the basis of different conditions and/or properties of the object and/or of the vehicle, which are described below. The risk of collision may also be described as a collision probability. If several objects are present in the monitored environment of the vehicle, the risk of collision may of course be determined for each of the several objects. The risk of collision may be determined continuously, in particular periodically.

Furthermore, the environment monitoring unit is configured to detect an object as the collision object for which there is a risk of collision and which is present outside the attention area. This means that the collision object is present outside the operator's attention area. The environment monitoring unit receives the attention area from the attention-area determination unit and then determines whether the object for which there is a risk of collision is present in the attention area received. Only if the object for which there is a risk of collision is present outside the attention area is this object also determined as a collision object. This determination of the object as a collision object may also take place continuously in order to take account of a shift in the attention area of the operator and/or a change in the relative position between the vehicle and the object. For example, an object for which there is a risk of collision may initially be present outside the attention area and thus be detected as a collision object. However, the operator may direct his/her field of view and thus the attention area toward the object. A risk of collision is then still present for the object, but it is no longer detected as a collision object.

The monitoring unit furthermore comprises an output unit configured to output a warning signal when detecting the collision object. This means that the output unit only outputs the warning signal when the collision object has been detected. This means that the output of the warning signal indicates that an object for which there is a risk of collision is present outside the attention area. If the object for which there is a risk of collision is located in the attention area, it is consequently not detected as a collision object and the output unit does not issue a warning signal. In this way, the operator can be reliably warned of the collision object. On the other hand, the output of the warning signal is prevented for objects for which there is a risk of collision but which are present in the attention area so that it can be assumed that the operator is aware of them. As a result, a possible disturbance of the operator during the operation of the vehicle is avoided.

In particular, the output unit may be configured to output an optical and/or acoustic and/or haptic warning signal. This means, the output unit may output an optical warning signal or an acoustic warning signal or a haptic warning signal. The output unit may also output a combination of at least two of these signals. As a result, the operator can be effectively warned of the collision object, since the warning signal can be perceived by different sensory organs. The warning signal may be individually customized. In this way, environmental conditions that occur during the operation of the vehicle may be taken into account. For example, in a noisy environment, such as a construction site, a combination of a visual warning signal and a haptic warning signal may be issued. Furthermore, a type of the different warning signals may also be adapted. For example, a volume and a tone of the acoustic warning signal, a vibration pattern, and a vibration strength of the haptic signal as well as a brightness and a display of the visual warning signal may be set. In this way, adapting to the operator's preference is possible.

According to an aspect, the environment monitoring unit may be configured to determine the risk of collision for an object as a function of a distance between the vehicle and the object. Alternatively or additionally, the environment monitoring unit may be configured to determine the risk of collision as a function of a relative speed between the vehicle and the object. For example, a risk of collision is assumed for an object that is present within a predetermined distance from the vehicle. A risk of collision may also be assumed if the object and the vehicle are moving toward each other at a predetermined relative speed or faster. The aspects of distance and relative speed may also be combined. A risk of collision may be assumed if the object is within the specified distance from the vehicle and/or is moving toward the vehicle at the specified speed or faster. In this way, a risk of collision and therefore also the collision object can be determined in a simple but effective way. It is conceivable that the predetermined distance and/or the predetermined relative speed are set the same over the monitored area. However, it is also possible for different values to be set for the predetermined distance and/or the predetermined relative speed over the monitored area. The different values for the predetermined distance and/or the predetermined relative speed may have a continuous or a discrete transition.

According to a further aspect, the environment monitoring unit may be configured to determine the risk of collision for an object depending on a type of the vehicle. For example, vehicles that are operating in a stationary state have a lower risk of collision with an object than vehicles that are moving, i.e. being driven, during operation. This influence may be taken into account, for example, when determining the specified distance within which there is a risk of collision. Furthermore, the value of the specified relative speed may be determined accordingly. Furthermore, components of the vehicle that protrude from the vehicle may be taken into account when determining the risk of collision. Alternatively or additionally, the environment monitoring unit may be configured to determine the risk of collision for an object depending on the intended purpose of the vehicle. For example, an excavator may be used for stationary excavation of a pit, but also for moving heavy objects from one location to another. In the first case, there is a risk of collision for objects at a comparatively short distance from the vehicle, whereas in the second case, there may also be a risk of collision for objects that are further away from the vehicle due to the movement of the excavator. The different intended use may be taken into account, for example, by adjusting the specified distance and/or the specified relative speed accordingly. As a result, the risk of collision may be appropriately determined according to the vehicle type and/or the respective application.

The environment monitoring unit may be configured to determine the risk of collision for an object depending on an operation of the vehicle. For example, an operating signal that is input via an operating element of the vehicle, such as an operating lever or an accelerator pedal, may be obtained or tapped by the environment monitoring unit. Furthermore, the environment monitoring unit may determine an operating pattern and take it into account when determining the risk of collision. For example, it may be determined that an excavator is excavating a pit in one direction and unloading the excavated material by turning the excavator through a predetermined angle. As a result, it can be assumed that the operator's attention is focused on an area of an excavator arm and/or of an excavator bucket during operation. During rotation, however, a rear end of a house also swings back and forth, so that there is an increased risk of collision in this area. This can be taken into account by specifying the predetermined distance within which there is a risk of collision with an object. In particular, the predetermined distance is increased around the rear end of the house in order to determine a risk of collision at an early stage and to output the warning signal in good time if an object for which there is a risk of collision is present outside the attention area. In this way, an appropriate warning may be given to the operator of the vehicle. Advantageously, the predetermined distance is increased only in the range of the predetermined angle in which the rear end of the excavator's house swings back and forth.

The output unit may comprise at least one optical display element. The optical display element is preferably arranged in a typical attention area. The typical attention area is an area to which the operator's attention is directed most of the time during operation of the vehicle. For example, in the case of an excavator, the operator's attention is usually focused on the excavator bucket, so that the optical display element is arranged in a line of sight from the operator to the excavator bucket or in the vicinity thereof. The optical display element may have a display, which may also be configured as a touch display. The display may also be used for other indications apart from the output of the optical warning signal. A signal light, such as an LED light, is also conceivable. It is also possible for several optical display elements to be present. For example, a display and several signal lights may be provided. Preferably, one of these optical display elements, particularly preferably the display, is arranged in the attention area typical of the vehicle. Processing for outputting the optical warning signal may take place in a control unit of the warning device or in the optical display element itself.

The output unit and the optical display element may be configured to display a direction in which the collision object is present on the optical display element. The direction may be displayed by the display element itself. For example, an arrow pointing in the direction in which the collision object is present may be shown on the display. The arrow may be superimposed, i.e. displayed in the form of an overlay. Alternatively or additionally, the direction may also be output by driving an optical display element in the direction in which the collision object is present. For example, a signal light may be specifically controlled.

As described above, the environment monitoring unit may comprise an image detection element, such as a camera. The output unit and the optical display element may be configured to display or superimpose an image detected by the image detection element on the optical display element. For example, the optical display element may be a display. The detected image may be integrated into a display already shown on the display or may be superimposed on it. The collision object may be highlighted in the image shown on the optical display element, e.g. outlined in color or flashing. In this way, the operator can quickly recognize the collision object.

The output unit may comprise several optical display elements and may be configured to output the warning signal via the optical display element that is present in the attention area of the operator or that is closest to it. For example, several displays or signal lights may be present. The output unit receives an attention area from the attention determination unit and then determines which of the optical display elements are present in the attention area. The optical warning signal is then displayed on the optical display element or optical display elements located in the attention area. In the event that none of the optical display elements is present in the attention area, the optical display element that is closest to the attention area, i.e. that is the closest to the attention area, may be activated. This allows the operator to perceive the output of the optical warning signal at least by peripheral vision.

The output unit may have at least one haptic output element that is arranged in or on a vehicle component that is in direct contact with the operator. The haptic output element may preferably be a vibration element. The vehicle component may be a seat or an operating element, such as an operating lever or a steering wheel, of the vehicle. By outputting the haptic warning signal through the haptic output element, the operator can be reliably warned of the collision object even in a noisy environment.

In particular, the output unit may comprises several haptic output elements arranged in/at one or more components that are in direct contact with the operator. The several haptic output elements may also be formed by areas of a haptic output element being independently controllable. In this case, the output unit may be configured to drive the haptic output elements according to a direction in which the collision object is present. For example, as is common with excavators, the vehicle may have several operating elements, e.g. two operating levers, in each of which a haptic output element is arranged. The output unit then controls the haptic output element in the direction of which the collision object is present. This means that the operator's attention can be reliably directed in the direction in which the collision object is present.

The output unit may comprise at least one loudspeaker or headphones. Headphones are, for example, in-ear headphones, half-in-ear headphones, on-ear headphones, over-ear headphones, head loudspeakers, or bone-sound headphones. The headphones may also be configured as hearing protection or as part of a radio device. As a result, the acoustic warning signal may be issued to the operator. Headphones offer the advantage that the operator may reliably hear the warning signal even in a noisy environment.

In particular, the output unit may comprise several loudspeakers. The several loudspeakers may be arranged in different directions around the operator so that they enable directional output of the warning signal. Alternatively, the headphones may be configured for spatial audio output. The output unit may then be configured to output the acoustic signal corresponding to a direction in which the collision object is present. When using headphones, a rotation of an operator's head may be taken into account to correctly indicate the direction. The rotation of the head may be detected by the headphones themselves and/or by the attention-area determination unit. Consequently, the direction in which the collision object is present may be indicated to the operator using the acoustic warning signal. The operator can then quickly detect the collision object.

Furthermore, the warning device may comprise an input unit configured to receive an input for acknowledging the collision object. As a result, the operator may confirm that he/she has detected the collision object and will take it into account when operating the vehicle. As a result, disturbing the operator due to the continuous output of the warning signal may be prevented. Furthermore, the input unit may be configured to receive an input for initializing an environment in which the vehicle is to be used. For example, an excavator is used on a narrow construction site in which several objects represent a collision object. However, the operator is aware of this and would be unnecessarily disturbed during operation by the warning signal. In this case, he/she may confirm to the warning device that he/she will take the collision objects into account during operation. Consequently, the existing collision objects are acknowledged and no longer detected as collision objects. However, if a new collision object appears, the operator is reliably warned of this by outputting the warning signal. The input unit may be formed by a dedicated input element, such as an input button. Alternatively or additionally, the input unit may also be formed by a corresponding display on a touch display, which preferably also forms the optical display element.

The output unit may be configured to adapt and output the warning signal according to the risk of collision. Accordingly, the optical and/or haptic and/or acoustic warning signal may be adapted according to a changing risk of collision. For example, the warning signal may be changed when the vehicle and the collision object move toward each other, making a collision more likely. For example, a brighter visual display may be used. A different color, e.g. a signal color, may also be used for the visual display. In the case of a flashing display, a flashing frequency may be adjusted. Furthermore, a volume and/or a tone and/or an output frequency of the acoustic warning signal may be adjusted. In addition, a strength and/or a vibration pattern of the haptic warning signal may be adjusted. In this way, the operator is reliably warned of an increasing risk of collision.

Furthermore, the warning device may include a stopping unit that is configured to stop the operation of the vehicle in the event of an imminent collision with the collision object. This means that the environment monitoring unit has detected a collision object and the operator is in the process of causing a collision between the vehicle and the collision object via an operation. For example, the operator may make a turning movement of the excavator in which the excavator arm or a rear end of a house would collide with the collision object. The stopping unit may recognize this because the collision object is within a swivel radius. In this case, the stopping unit interrupts the operation of the vehicle so that a collision with the collision object is avoided. The stopping unit may be formed in that the monitoring device provides the warning signal to another control unit of the vehicle via a vehicle network (e.g. CAN network) and the warning signal is processed by the other control unit accordingly to stop the operation.

Furthermore, the present disclosure may also be embodied as a vehicle having a warning device according to the aspects described above.

Hereinafter, embodiments of the present disclosure will be described with reference to the figures. In the figures, identical or corresponding elements are assigned the same reference sign. The figures show:

### BRIEF DESCRIPTION OF THE DRAWINGS

FIG. 1 shows a schematic block diagram of a warning device according to the disclosure;

FIG. 2 shows a schematic side view of an excavator in which the warning device according to the disclosure is installed;

FIG. 3 shows a schematic top view of the excavator;

FIG. 4 shows a schematic top view of a cabin of the excavator;

FIG. 5 shows a schematic view of a display installed in the cabin of the excavator;

FIG. 6 shows a schematic top view of the excavator during a rotary movement of a house of the excavator;

FIG. 7 shows a schematic top view of the cabin of the excavator during the turning movement;

FIG. 8 shows a schematic top view of the excavator during travel of the excavator with the house rotated; and

FIG. 9 shows a schematic top view of the cabin of the excavator while the excavator is moving.

### DETAILED DESCRIPTION

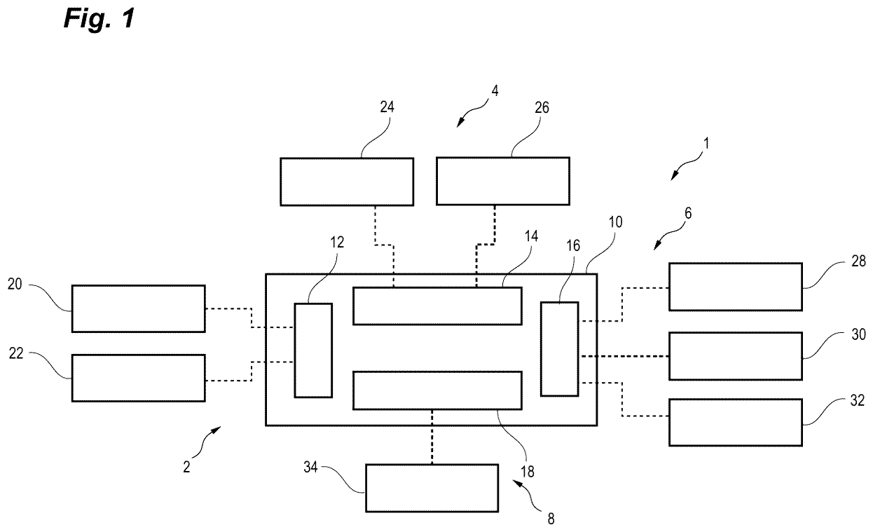

FIG. 1 shows a schematic block diagram of a warning device 1 according to the disclosure, which has an attention-area determination unit 2, an environment monitoring unit 4, an output unit 6 and an input unit 7. Furthermore, the warning device 1 has a control unit 10 which has a CPU, a memory for storing a computer program which can be executed by the CPU, and input/output interfaces. In the CPU, an attention-area determination portion 12, an environment monitoring portion 14, an output portion 16 and an input portion 18 are formed as functional portions by executing the computer program. The functional portions 12 to 18 interact with external components via the input/output interfaces in order to form the respective units 2 to 8. Furthermore, the functional portions are capable of exchanging information or data with each other.

The attention determination unit 2 comprises the attention determination portion 12, an operator camera 20 and a posture sensor 22. The operator camera 20 detects a head of an operator of a vehicle in which the warning device 1 is installed. An algorithm for tracking a face and/or eyes of the operator is implemented in the attention determination portion 12 in order to determine a field of view, in particular a binocular field of view, of the operator. Methods known from the prior art may be used for this purpose. An inclination sensor is installed in a seat of the vehicle as a posture sensor 22, so that the inclination of the seat may also be used to determine the operator's field of view. In this way, the field of view may be determined as an attention area, to which the operator's attention is directed, inside and outside the vehicle, i.e. a cabin of the vehicle. In order to determine the attention area, variables for a normal field of view of a person may be used. For example, a person may detect an area of approximately 210° in the horizontal plane. Vertically, the range is between 60° and 70° upward and between 70° and 80° downward. A safety range, e.g. 10°, may be subtracted from the specified ranges to enable the field of view and therefore the attention area to be reliably determined.

The environment monitoring unit 4 comprises the environment monitoring portion 14 as well as at least one camera 24 as an image detection element and at least one lidar sensor 26. The camera 24 and the lidar sensor 26 thus correspond to detection elements and at least partially detect an environment around the vehicle. The area in which the environment is monitored, i.e, the monitored environment, depends on a detection range of the camera 24 and of the lidar sensor 26. Each detection element has a detection area with a characteristic horizontal and vertical extension. The camera 24 and the lidar sensor 26 may have different detection areas and the environment may only be monitored within an overlapping area. The monitored environment may be enlarged by installing additional cameras 24 and lidar sensors 26. It is particularly preferable to completely monitor an environment around the vehicle. Furthermore, the detection elements may be inclined in relation to a horizontal plane in which they are installed in order to detect an area below or above the vehicle.

The environment monitoring portion 14 obtains the information detected by the camera 24 and the lidar sensor 26 and fuses it to detect one or more objects around the vehicle. Machine vision methods may be used for this purpose, for example.

Furthermore, the environment monitoring portion 14 determines a risk of collision or a collision probability for a detected object. For example, a risk of collision may be assumed for an object if the object is present within a predefined distance from the vehicle. Alternatively or additionally, a risk of collision may be assumed if the vehicle and the object are moving toward each other at a relative speed that is greater than or equal to a predefined relative speed. The predetermined distance and/or the predetermined relative speed may be defined as a function of a type of vehicle and/or an intended purpose of the vehicle. Furthermore, the predetermined distance and/or the predetermined relative speed may be determined as a function of an operating mode of the vehicle. The predetermined distance and/or the relative speed may each be set to an identical value along the monitored environment. However, different values may also be specified in each case, which have a continuous or a discrete transition.

If an object for which there is a risk of collision is present in the monitored environment, the environment monitoring portion 14 determines whether the object is present in the attention area or not. For this purpose, the environment monitoring portion 14 obtains information about the current attention area from the attention-area determination portion 12. If there is a risk of collision for an object and it is present outside the attention area, it is detected as a collision object.

The output unit 6 has the output portion 16, at least one display 28 as an optical output element, at least one loudspeaker 30 as an acoustic output element, and at least one vibration element 32 as a haptic output element. The output portion 16 receives information from the environment monitoring portion 14 that a collision object has been detected and then triggers the output of a warning signal via the display 28, the loudspeaker 30, and/or the vibration element 32. The warning signal may be configured in advance. The warning signal may also be adapted according to a risk of collision. For example, the warning signal may be output with a higher intensity if the collision object is at a shorter distance from the vehicle.

The input unit 8 is formed by the input portion 18 and at least one input button 34. The input portion 18 receives information about an actuation of the input button 34 as an input for acknowledging the collision object. This means that the operator uses the input to signal that he/she has noticed the collision object and will take it into account when operating the vehicle. Preferably, the display 28 of the output unit 6 may be configured as a touch display and the input button 34 may be displayed as part of a touch function on the display 28. Alternatively, the input button 34 may be formed by a haptic button that is attached to or integrated into the display 28, a dashboard, a steering wheel and/or an operating lever 54. For example, the collision object may be displayed on the display 28 via an image detected by the camera 24 and may be acknowledged by touching the display 28. Alternatively or additionally, the input portion 18 may receive an input for initializing an environment in which the vehicle is to be used by actuating the input button 34. The initialization acknowledges all collision objects in the environment around the vehicle. In this way, the warning signal may be prevented from interfering in a confined environment, such as a construction site, while the operator is reliably warned of a new collision object.

Furthermore, the warning device 1 may have a stopping unit, not shown, which has a stopping portion and a stopping actuator. The stopping portion acquires an operating signal for operating the vehicle, for example a signal from an operating lever or an accelerator pedal, and, upon detecting a collision object, determines whether a collision with the collision object would occur when operating the vehicle with the acquired operating signal. If this is the case, the stopping portion actuates the stopping actuator to stop the current operation caused by the operating signal. The stopping actuator may correspond to another control unit that is responsible for operating the vehicle. In order to trigger the stopping process, the stopping portion sends the warning signal via a vehicle network (e.g. CAN network) to the other control unit, which processes the warning signal accordingly and executes stopping of the operation. In this way, a collision with the collision object due to the operator operating the vehicle may be prevented.

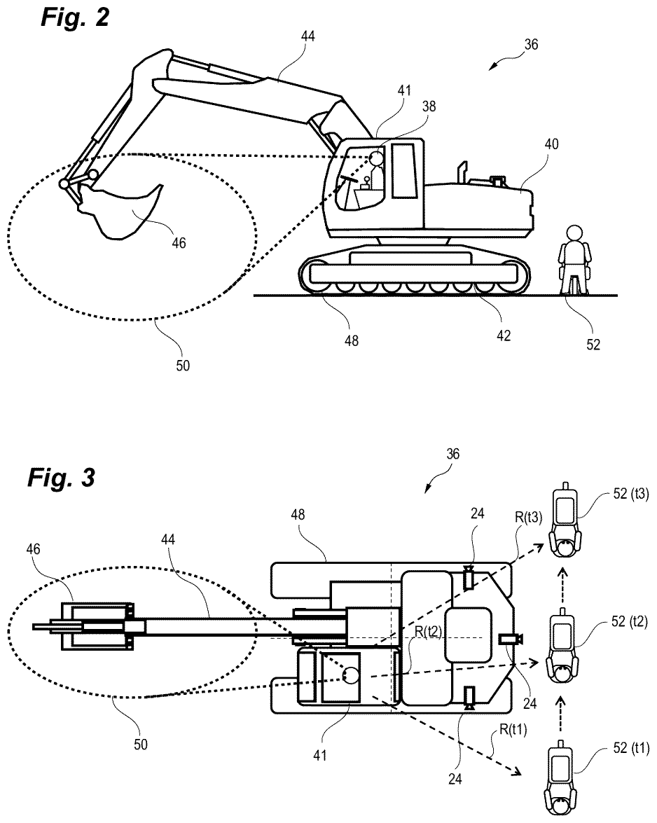

FIG. 2 schematically shows an excavator 36 as an example of a vehicle in which the warning device 1 according to the disclosure is installed. The excavator 36 is operated or controlled by an operator 38. The excavator 36 is configured in the present case as a crawler excavator, which has a house 40, which forms a cabin 41 for the operator, and an undercarriage 42, which are rotatable relative to each other. An excavator arm 44, at the end of which an excavator bucket 46 is mounted, is attached to the house 40. The undercarriage 42 has chains 48 for moving the excavator 36. In the example shown in FIG. 2, the attention of the operator 38, i.e. an attention area 50, is directed toward the excavator bucket 46 and an area located below it. The attention area 50 is not limited to a specific focal plane. Behind the excavator 36 there is a worker 52, which is detected as a collision object in the present case, since he/she is located outside the attention area 50.

FIG. 3 shows a schematic top view of the excavator 36 of FIG. 2. As already described with reference to FIG. 2, the attention area 50 is directed toward the excavator bucket 46. In FIG. 3, cameras 24 are shown which are attached to a rear end of the house 40 and are aligned to the left, to the rear and to the right with respect to the house 40. It should be noted that the lidar sensors are not shown for reasons of clarity. The worker 52 pushes a wheelbarrow and moves past the excavator 36 so that he/she is at a respective position at the different times t1, t2 and t3. Consequently, a direction R(t1), R(t2), R(t3), in which the worker 52 is present in relation to the house 40 and thus the operator 38, also changes at the respective times t1, t2, t3. Since the worker 52 is present outside the attention area 50, he/she is detected here as a collision object.

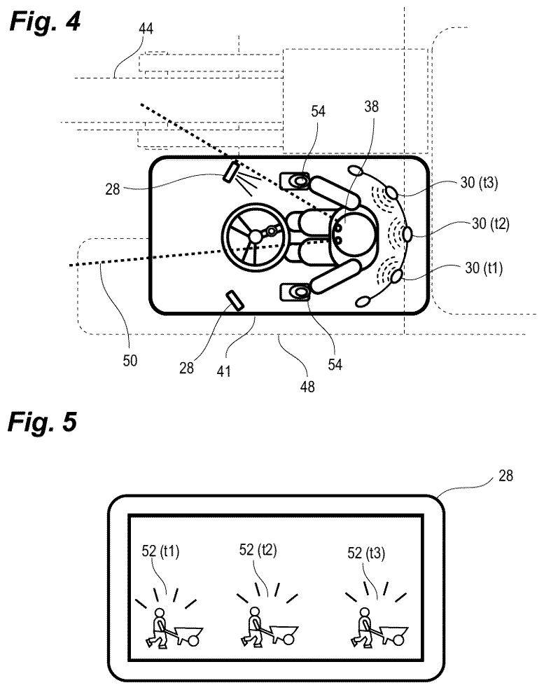

FIG. 4 shows a schematic top view of an interior of the cabin 41 of the excavator 36. In the cabin 41, two displays 28 are arranged to the left and right in front of the operator 38 in an area to which the attention of the operator 38 is directed most of the time during operation of the excavator 36. There are also two operating levers 54, which may be used to operate the excavator 36. A seat (not shown), on which the operator 38 sits during operation, is arranged in the cabin 41. The operating levers 54 and the seat correspond to vehicle components that are in direct contact with the operator 38. Vibration elements 32 are arranged in the operating levers 54 and the seat. Behind the operator 38, several loudspeakers 30 are arranged in a semicircle around the operator 38.

As already described with reference to FIGS. 2 and 3, the attention area 50 is directed toward an excavator bucket 46, while a worker 52, who represents a collision object, moves past behind the excavator 36. In order to draw the attention of the operator 38 to the worker 52, an optical, an acoustic and a haptic warning signal are output in the present case. However, it is also conceivable that only one of the warning signals or a combination of two of these warning signals is output. In the present case, the visual warning signal is output via the display 28, since this is located in the attention area 50. In addition, the individual loudspeakers 30 are activated successively at the times t1, t2 and t3 in accordance with the direction R, which changes with the movement of the worker 52, in order to output the acoustic warning signal. In this way, the operator 36 can be informed of the direction in which the worker 52, i.e, the collision object, is present. Furthermore, the vibration element 32 in the seat is controlled to output the haptic warning signal, so that the operator is informed that the worker 52 is behind him/her.

FIG. 5 shows an output of the optical warning signal via the display 28. As mentioned with reference to FIG. 2, cameras 24 are arranged on the house 40, which detect an image of the monitored environment. An image showing the worker 52 and detected by one of the cameras 24 may be displayed on the display 28 so that the operator 38 may perceive the worker 52 without directing the attention area 50 to the worker 52. A composite image consisting of multiple images detected by the cameras 24 may also be displayed on the display 28. The worker 52 may be highlighted in the displayed image, for example with a colored border or flashing, in order to signal to the operator 38 that the worker 52 represents the collision object. The operator 38 may acknowledge the worker 52 by pressing the input button and prevent the warning signals from being output. For example, the display 28 may be configured as a touch display and the operator 38 may acknowledge the worker 52 by tapping on the display 28.

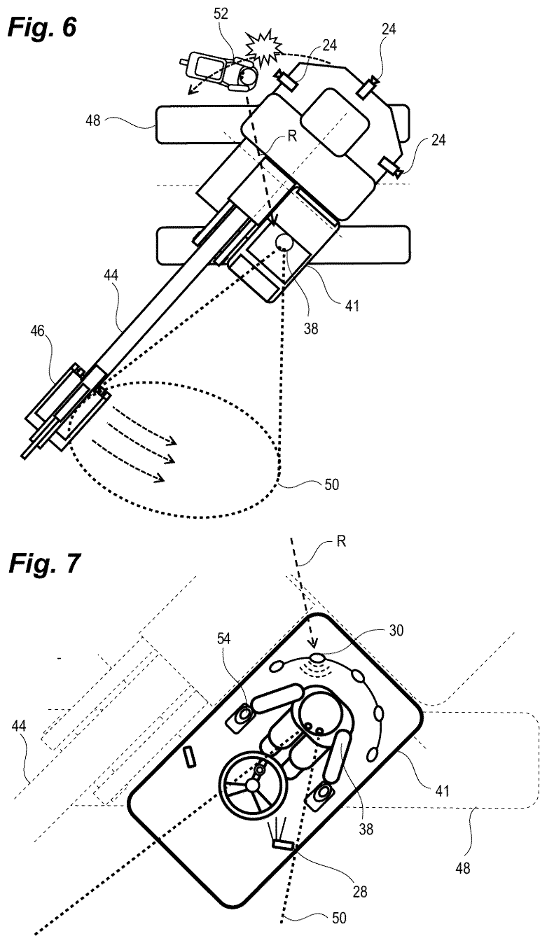

FIG. 6 shows a schematic top view of the excavator 36 during a rotational movement of the house 40. The attention area 50 of the operator 38 is directed toward an area to which the excavator bucket 46 is pivoted. The worker 52 is located, as seen from the house 40, to the rear right in the direction R. Since the worker 52 has a small distance to the excavator 36, it is located within a pivoting radius of a rear end of the house 40.

FIG. 7 shows a schematic top view of the cabin 41 of the excavator 36. As described with reference to FIG. 6, the attention area 50 is directed toward an area toward which the excavator bucket 46 is pivoted and the worker 52 as the collision object is located in the direction R. In order to make the operator 38 aware of the worker 52, an optical, an acoustic and a haptic warning signal are output in the present case. The visual warning signal is output via the display 28, which is located to the front right of the operator 38, since it is located in the attention area 50 of the operator 38. In addition, the optical warning signal is output via the loudspeaker 30, which corresponds to the direction R. In addition, the haptic vibration signal is output via the vibration elements 32 in the seat and in the right operating lever 54 to inform the operator 38 that the worker 52 is located as the collision object to the rear right in relation to the house 40, i.e, the operator 38.

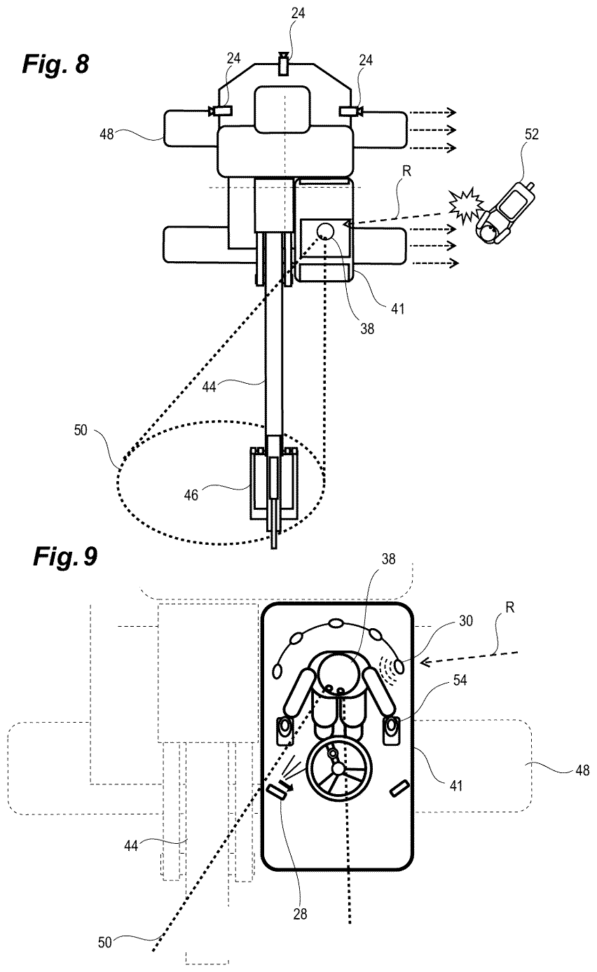

FIG. 8 shows a schematic top view of the excavator 36 during moving from left to right with a house 40 rotated by 90°. The attention area 50 is directed toward an area that is slightly offset to the right in relation to the excavator bucket 46, so that falling of transported goods may be detected. To the left in relation to the house 40, i.e, the operator 38, the worker 52 is located in the direction R and is detected as the collision object.

FIG. 9 shows a top view of the cabin 41 of the excavator 36. As described in relation to FIG. 8, the worker 52 is located in the direction R. In order to inform the operator 38 of the presence of the worker 52 as the collision object, an optical, an acoustic and a haptic warning signal are output in the present case. The optical warning signal is output via the display 28, which is arranged to the left in front of the operator 38, since this display 28 is in the attention area 50 of the operator 38. The direction R may be indicated to the operator 38 by displaying a corresponding arrow on the display 28. The acoustic warning signal is output via the loudspeaker 30, which corresponds to the direction R. In addition, the haptic warning signal is output via the left operating lever 54. As a result, the operator 38 may be reliably alerted to the worker 52 as the collision object.

Above, embodiments of the present disclosure have been described. It should be noted that the described embodiments are merely non-limiting examples of the implementation of the present disclosure.

### REFERENCE NUMERAL LIST

1 warning device
2 attention-area determination unit
4 environment monitoring unit
6 output unit
8 input unit
10 control unit
12 attention-area determination portion
14 environment monitoring portion
16 output portion
18 input portion
20 operator camera
22 posture sensor
24 camera
26 lidar sensor
28 display
30 loudspeaker
32 vibration element
34 input button
36 excavator
38 operator
40 house
42 undercarriage
44 excavator arm
46 excavator bucket
48 chains
50 attention area
52 worker
54 operating lever
R direction

1. A warning device for warning an operator of a vehicle of a collision object during operation, the warning device comprising:
an attention-area determination unit configured to determine an attention area, which is an area to which an attention of the operator is directed,
an environment monitoring unit configured to at least partially monitor an environment around the vehicle, to determine a risk of collision for an object that is present in the monitored environment, and to detect an object as the collision object for which there is a risk of collision and which is present outside the attention area, and
an output unit configured to output a warning signal when detecting the collision object.

2. The warning device according to claim 1, wherein
the output unit is configured to output an optical and/or an acoustic and/or a haptic warning signal.

3. The warning device according to claim 1, wherein
the environment monitoring unit is configured to determine the risk of collision for an object as a function of a distance and/or a relative speed between the vehicle and the object.

4. The warning device according to claim 1, wherein
the environment monitoring unit is configured to determine the risk of collision for an object depending on a type of the vehicle and/or an intended purpose of the vehicle.

5. The warning device according to claim 1, wherein
the environment monitoring unit is configured to determine the risk of collision for an object depending on an operation of the vehicle.

6. The warning device according to claim 1, wherein
the output unit comprises at least one optical display element.

7. The warning device according to claim 6, wherein
the output unit and the optical display element are configured to display a direction in which the collision object is present on the optical display element.

8. The warning device according to claim 6, wherein
the environment monitoring unit comprises an image detection element, and
the output unit and the optical display element are configured to display or superimpose an image detected by the image detection element on the optical display element.

9. The warning device according to claim 6, wherein
the output unit comprises several optical display elements and is configured to output the warning signal via the optical display element that is present in the attention area of the operator or that is closest to it.

10. The warning device according to claim 1, wherein
the output unit comprises at least one haptic output element arranged in/on a vehicle component in direct contact with the operator.

11. The warning device according to claim 10, wherein
the output unit comprises several haptic output elements arranged in/at one or more components that are in direct contact with the operator, and is configured to drive the haptic output elements according to a direction in which the collision object is present.

12. The warning device according to claim 1, wherein
the output unit comprises at least one loudspeaker or headphones.

13. The warning device according to claim 12, wherein
the output unit comprises several loudspeakers or the headphones are configured for spatial audio output, and
the output unit is configured to output the acoustic warning signal corresponding to a direction in which the collision object is present.

14. The warning device according to claim 1, comprising:
an input unit configured to receive an input for acknowledging the collision object and/or an input for initializing an environment in the vehicle is to be used.

15. The warning device according to claim 1, wherein
the output unit is configured to adapt and output the warning signal according to the risk of collision.
